(19) United States
(12) Patent Application Publication
(10) Pub. No.: US 2025/0057360 A1
(43) Pub. Date: Feb. 20, 2025

(54) CONSTRUCTIVE ARRAY INTRODUCED INTO AN EDIBLE OIL AND FAT FILTERING DEVICE

(71) Applicant: FRAIS INDUSTRIA, COMERCIO, IMPORTACAO E EXPORTACAO LTDA, Campinas (BR)

(72) Inventor: Fernando Luis Pereira CAZZOLI, CAMPINAS (BR)

(21) Appl. No.: 18/740,916

(22) Filed: Jun. 12, 2024

(30) Foreign Application Priority Data
Aug. 18, 2023 (BR) 2020 23016681 0

(51) Int. Cl. A47J 37/12

(52) U.S. Cl. CPC A47J 37/1223

(57) ABSTRACT

A new edible oil and fat filtering device, designed to extend the useful life of oils used in frying procedures, designed to extend the useful life of oils used in frying procedures, due to the fact that it has reduced dimensions, enabled to be immersed in the frying pan directly into the oil to be filtered, thus eliminating the time spent with the removal and transport of the hot oil, compared to traditional filtering methods, reducing the filtering time and making the process safer; and at the same time keeping the oil viscosity low and making it easier to pass through the filtering element.

### FIELD OF THE INVENTION

The present application is in the field of edible oil and fat filtering devices.

### BACKGROUND OF THE INVENTION

In snack bars, restaurants, fried cookies shops, and the like, oil is largely used in the frying process. Due to said reason, there is a need to extend the useful life of the oil and thus assure the quality of same and food.

As part of the state of the art, mention is made to document BRMU8903423-6, published on Oct. 15, 2013, referring to “A FILTERING TABLE FOR OILS AND FATS” where, according to the abstract thereof: “A FILTERING TABLE FOR (plant or animal) OILS AND FATS, comprising a table provided with supports (1) for placing PET bottles containing the product to be filtered upside down; wherein said dirty oil can flow to over a suitable surface (3), passing through a filter (2) and then falling into a containment (8) and heating (9) box, and the oil is kept at a certain temperature within said box, circulates through a filtering system (7) to be polished, and is finally taken out of the table to be stored.”

As can be seen, it is a filtering table which obviously cannot be immersed into the oil, the reason why only the filtering of oil stored in PET bottles is carried out. Therefore, it exhibits characteristics completely distinct from those of the object in question, thus being part of the state of the art, but it is not considered to be a document of particular relevance.

As part of the state of the art, mention is made to document BRMU9002208-4 of the same applicant, published on Mar. 5, 2013, referring to “AN EDIBLE OIL AND FAT FILTERING DEVICE” wherein, according to the abstract thereof, “AN EDIBLE OIL AND FAT FILTERING DEVICE designed to extend the useful life of oils and fats used when food stuff is fried. It is characterized by being portable, robust, and has reduced dimensions and other characteristics which make it possible to immerse same into the oil to be filtered, thus eliminating the time spent in the removal and transport of the hot oil, thus reducing the filtering time and making the process safer and reducing the heat loss, thus keeping the oil hot for a longer time and consequently keeping the oil viscosity low and making it easier to pass same through the filtering element. It is comprised of a centrifugal pump (4, 5, 6, 7, 8) which sucks the oil through an eye of the rotor (8) and creates an ascending flow of oil which is filtered by a filtering element (14) and pressed against the stops (13) of the filtering device by a filter supporting grid (9) under the mechanical pressure of a button (11).”

It can be seen that the object of the above described document, despite the fact that it is directly immersed into the oil to be filtered, still shows a few inconveniences, such as:
difficult installation of the filter;
difficult closure of the door;
high temperature inside the command head;
lack of ventilation in the motor; and
dimensions and geometry which do not allow the same to be immersed into the fryer.

Therefore, to definitely solve the state of the art inconveniences the present filtering device was developed, the constructive array of which having reduced dimensions and other characteristics makes it possible to immerse same directly into the oil to be filtered in the frying element, compared to traditional filtering methods.

This makes the process safer, avoiding handling hot oil and therefore speeding up the filtering process, thus reducing the oil heat loss, an important factor in the filtering process, since it keeps the viscosity thereof low, thus making it easy to pass same through the filtering element, and therefore solving the above-mentioned inconveniences and providing other advantages in view of its conception.

### SUMMARY OF THE INVENTION

The claimed invention refers to a new constructive array introduced into an edible oil and fat filtering device, more particularly a device for filtering edible oil and fat, hereinafter simply called oil, filtering device, which was designed to extend the useful life of oils used in frying procedures. The fact that it has reduced dimensions, among other characteristics, makes it possible to immerse same in the frying pan directly into the oil to be filtered, thus eliminating the time spent with the removal and transport of the hot oil, compared to traditional filtering methods. This reduces the filtering time and makes the process safer. This reduction in time reduces the heat loss and keeps the oil hot, an important factor in a filtering process, since it keeps the oil viscosity low and thus makes it easy to pass it through the filtering element.

### BRIEF DESCRIPTION OF THE DRAWINGS

FIG. 1 is a perspective view of the new constructive array introduced in an edible oil and fat filtering device.

FIG. 2 is an exploded perspective view of the filtering device.

FIG. 3 is an exploded perspective view of the driving unit of the filtering device.

FIG. 4 is an exploded perspective view of the circulation container.

FIG. 5 is a perspective view of the filter support.

### DETAILED DESCRIPTION OF THE INVENTION

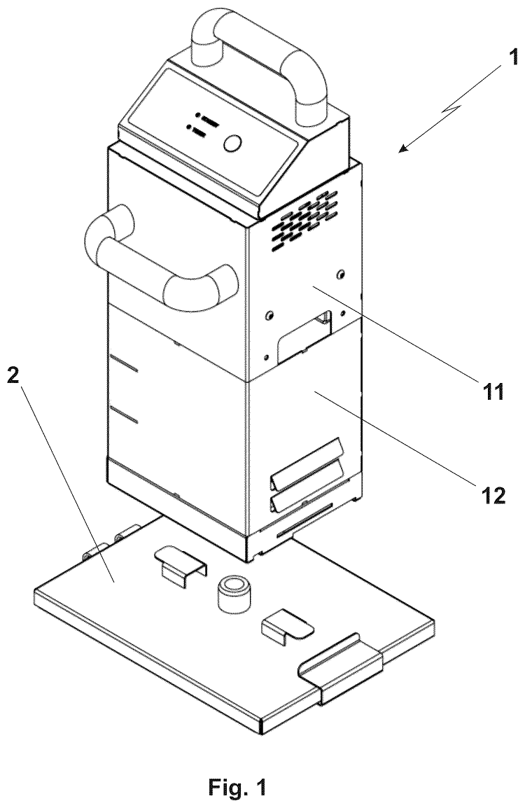

Referring to FIG. 1, the new constructive array introduced in an edible oil and fat filtering device comprises a filter (1) formed by a driving unit (11) and a circulation container (12) assembled on a filter support (2).

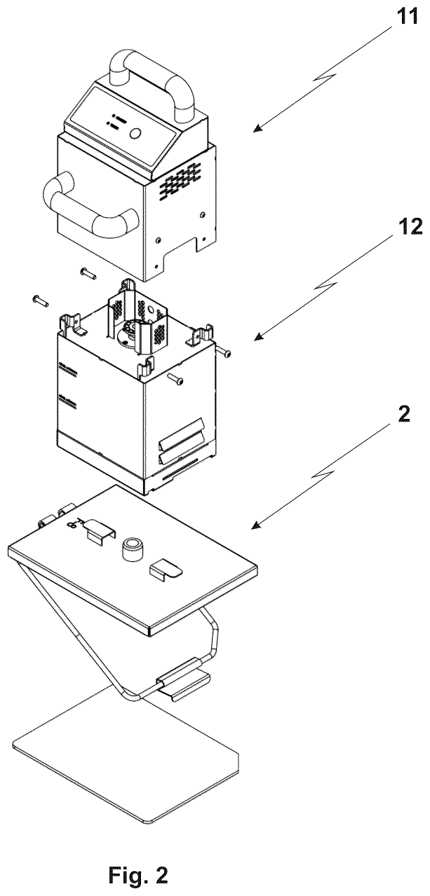

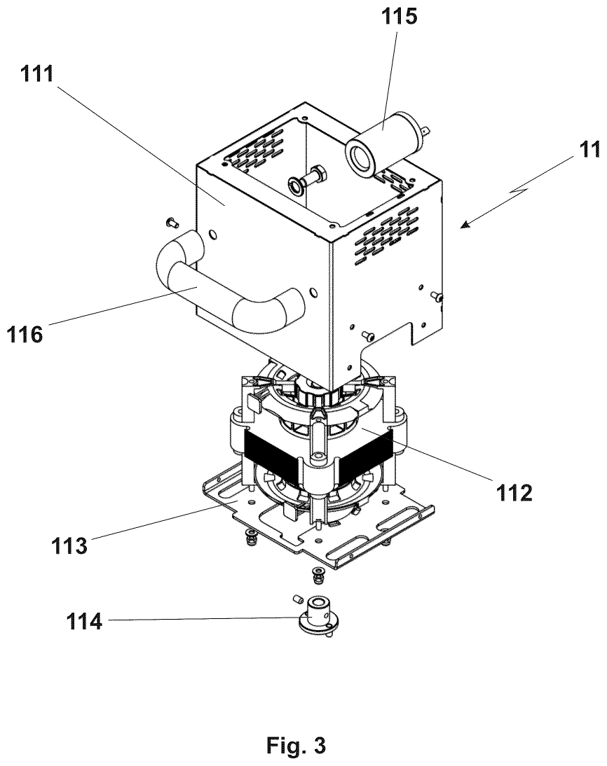

Referring now to FIGS. 2-4, the driving unit (11) is formed by an enclosure (111) which envelops the electric motor (112) and is assembled on a base (113) and attached through a fast press-fit coupling (114), and also provided with a start capacitor (115) and externally provided with a strap (116). Said driving unit (11) is connected to the circulation container (12) by the top coupling (121).

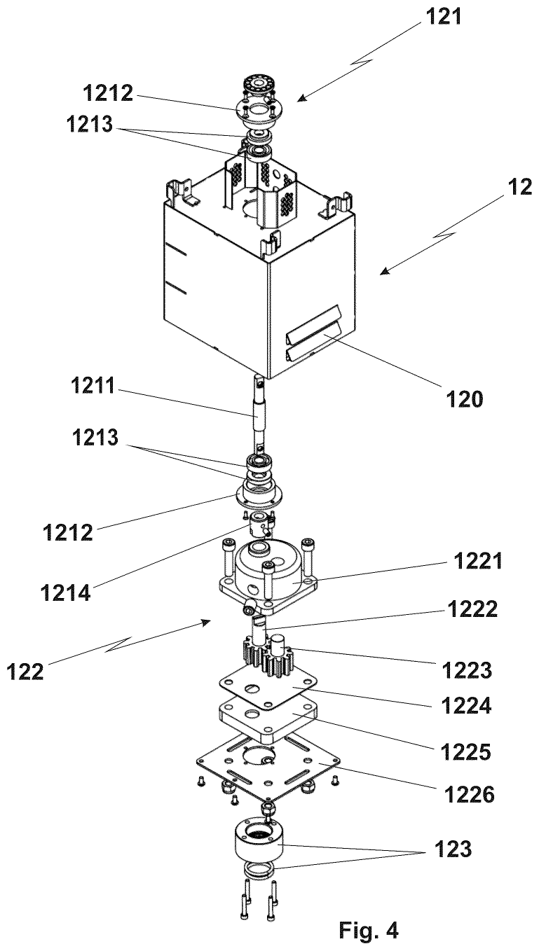

Referring now to FIG. 4, the circulation container (12) is externally provided with a plurality of opening tabs (120), and the top coupling (121) is internally provided with an axle (1211) to which the bearing (1212) containing ball bearings (1213) is assembled; at the lower end of the axle (1211) a fit coupling (1214) for the driving axle (1222) of the gearing pump unit (122) and gearings (1221, 1223 and 1224) and a suction chamber (1225 and 1226). Said filter (1) is coupled to the filter support (2) by a coupling bush (123).

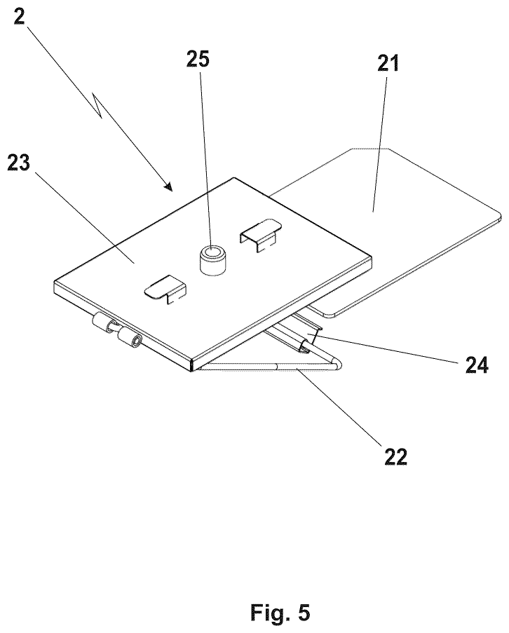

Referring now to FIGS. 1 and 5, the filter support (2) is formed by a filtering element (21) which is installed between the grid (22) and the pivoting frame (23) of the filter support (2), where the filtering element (21) is pressed against the pivoting frame (23) of the filter support (2) under the mechanical pressure exerted by locks (24), and an oil outlet (25) for filter (1) is also provided.

Referring now to FIGS. 2-4, with the obtained new constructive array introduced into an edible oil and fat filtering device, it is operated by an electric motor (112) which rotates the gearing pump unit (122) by the rotating axle (1211). This rotation of the gearing pump unit (122) transfers kinetic energy to the oil through the movement of the first, second and third gearings (1221, 1223 and 1224) of the gearing pump unit (122). The oil present in the first and second suction chamber (1225 and 1226) is forced to circulate through the filter support (2) into the gearing pump unit (122), thus forming a continuing circulating flow, and flows out fast towards the interior of the circulation container (12) to which the oil flows back through the opening tabs (12) into the fryer vat.

The new constructive array introduced into an edible oil and fat filtering device offers the following advantages compared to similar arrays known to date.
it is a portable, robust, and easy-to-clean filtering device;
it is extremely easy to handle automatically and requires almost no intervention by the operator;
it prevents premature loss of oil;
it is cost effective since the useful life of the motor is increased;
it is easy to assemble and disassemble for cleaning purposes;
its geometry is more suited for filtering purposes;
there is no danger of oil leakage since it works under low pressure;
it is made of 304 stainless steel;
more suitable and ergonomic handling straps;
suction pump (through gearings).

Therefore, the scope of the claimed invention should not be limited to constructive details, but only to the terms defined in the claim and equivalents thereof.

1. A constructive array introduced into an edible oil and fat filtering device, comprising a filter formed by a driving unit and a circulation container assembled on a filter support;
wherein the driving unit comprises an enclosure having a start capacitor and an external tab, the enclosure enveloping an electric motor that is attached to a base by means of fast fit coupling;
wherein the circulation container comprises:
a plurality of opening tabs,
an axle,
a bearing containing ball bearings attached to the axle,
a fit coupling attached to lower end of the axle, and
a gearing pump unit coupled to the fit coupling having a first, a second and a third gearing, a driving axle, and a first and a second suction chamber;
wherein the filter support comprises a filtering element installed between a grid and a pivoting frame having an oil outlet, the filtering element pressed against the pivoting frame under mechanical pressure exerted by locks; and
wherein the driving unit is connected to the circulation container by a top coupling and wherein the filter is coupled to the filter support by a coupling bush.
